(19) United States
(12) Patent Application Publication
(10) Pub. No.: US 2024/0180205 A1
(43) Pub. Date: Jun. 6, 2024

(54) METHOD AND APPARATUS FOR PRESERVING BEVERAGES

(71) Applicant: LANXESS DEUTSCHLAND GMBH, Köln (DE)

(72) Inventors: Erasmus VOGL, Köln (DE); Jonas BURGHOLZ, Köln (DE)

(21) Appl. No.: 18/285,864

(22) PCT Filed: Mar. 23, 2022
(86) PCT No.: PCT/EP2022/057698

§ 371 Date: Oct. 6, 2023

(30) Foreign Application Priority Data
Apr. 7, 2021 (EP) 21167212.6

(51) Int. Cl. A23L 2/44; B01F 35/21; B01F 35/22; B01F 35/71; C12H 1/14

(52) U.S. Cl. CPC A23L 2/44; B01F 35/2111; B01F 35/2203; B01F 35/717613; C12H 1/14

(57) ABSTRACT

An apparatus for preserving beverages is provided with a measuring device which is suitable and intended to determine a flow rate of a liquid flowing through a beverage line and with a pump device which delivers a preservative and in particular dialkyl dicarbonates into the beverage line, wherein a delivery line is provided which opens into the beverage line and the pump device delivers the dialkyl dicarbonates through this delivery line and wherein the pump device can be controlled as a function of a flow rate determined by the measuring device, wherein the pump device is constructed as a reciprocating piston pump.

### CROSS-REFERENCE TO RELATED APPLICATIONS

This application claims priority to PCT Application No. PCT/EP2022/057698, having a filing date of Mar. 23, 2022, based on European Application No. 21 167 212.6, having a filing date of Apr. 7, 2021, the entire contents both of which are hereby incorporated by reference.

### FIELD OF TECHNOLOGY

The following relates to a method and an apparatus for preserving beverages and the use of the apparatus for this purpose.

### BACKGROUND

Preservatives such as dialkyl dicarbonates, sulfur dioxide, natamycin, benzoates or sorbates are used in the beverage industry for cold sterilization of non-alcoholic carbonated or still fruit juice drinks, fruit juices, wines, non-alcoholic wines, ciders, iced teas and other beverages. Dialkyl dicarbonates, such as in particular dimethyl dicarbonate or diethyl dicarbonate, represent a special cold sterilizing agent that has a number of advantages. The outstanding advantage lies in the fact that taste and color are not affected, in contrast to hot filling. Also compared to persistent preservatives, such as sodium benzoate or benzoic acid or potassium sorbate or sorbic acid, the advantage is especially the absence of any taste impairment and the disappearance of the effect. Due to the decomposition of the dialkyl dicarbonates into harmless components, no preservative is consumed by the actual consumer.

Compared to cold aseptic filling, the considerably lower investment costs in plant technology are known to be an advantage when using dialkyl dicarbonates.

According to the state of the conventional art, only on-line diaphragm dosing pumps are used for the addition of dialkyl dicarbonates. This is necessary because the amount of beverage to be treated is not fixed from the outset. An advantage of diaphragm pumps is that their pumping chamber is completely enclosed.

Devices and methods have been described which allow dialkyl dicarbonates to be introduced into wine barrels with relatively simple apparatus according to the principle of water jet pumps. However, this method only works if the amount of beverage is known exactly or corresponds exactly to the amount in the standardized wine barrels. This includes the apparatus, which became known in WO 2019 179 695 A1, for precisely defined quantities of wine in barrels. This operates on a much simpler principle, but only works with smaller and precisely defined quantities of beverage before starting. It is not to be used for the usual on-line dosing.

Apparatus with Diaphragm pump consists of a magnetically or electrically driven diaphragm pump, storage vessels, a device attached to the beverage line for atomizing the dialkyl dicarbonate, a flow meter attached to the beverage line, and an electronic control system. Dosing pumps of this type are usually permanently installed in the beverage line.

The mode of operation of these devices is based on the on-line measurement of the beverage flow rate prevailing in the beverage pipe and the quantity of dialkyl dicarbonate to be dosed calculated in parallel. Dialkyl dicarbonate is thus proportionally dosed into the beverage pipe in the required quantity. Examples of these pumps are the Velcorin®DT units from Lanxess.

In the treatment of beverages, for example non-alcoholic soft drinks or wine or mixed beer beverages, cold sterile treatment with dialkyl dicarbonates may be necessary, for example to combat bacteria or yeasts. The aforementioned dosing devices are therefore used for treatment.

The diaphragm pumps described above work satisfactorily but are accompanied by certain limitations. For example, the diaphragm dosing pumps used are relatively large and heavy and must therefore usually be transported with special mechanical devices for carrying loads. It would be desirable to have dosing pumps that can easily be carried by one person. This would allow much simpler and more flexible use.

In addition, diaphragm dosing pumps with metal diaphragms are relatively expensive. This is due to the relatively solid design that is required to ensure reliable functioning. Devices with a much simpler design would be desirable.

In addition, the use of a diaphragm dosing pump requires sufficient time for set-up and installation. For example, it must be ensured that the pumps are installed horizontally. Desirable here would be devices that can be installed relatively uncomplicatedly and quickly, in particular in the bottling of wine, where the corresponding devices are only used for a short time during the year and therefore a quick and uncomplicated installation would be particularly advantageous.

Furthermore, the diaphragms of diaphragm dosing pumps can break or develop fine cracks. This can lead to oil from the oil pressure area of the diaphragm getting into the beverage. In order to reliably prevent incorrect dosing, it is therefore necessary to install complex monitoring devices in these pumps in order to reliably detect a diaphragm rupture.

All known pump devices for preservation with dialkyl dicarbonates work with a membrane. One reason for this may be the previous assumption that only a diaphragm allows safe use of dialkyl dicarbonates, as these dialkyl dicarbonates are sometimes very irritating. With many other pumps, such as gear pumps or piston pumps, the product-carrying area is usually not completely sealed off, so that a minimal product leakage cannot be prevented. In fact, when using a diaphragm metering pump, the separation of dialkyl dicarbonate-bearing areas from the environment/outside is comparatively easy, complete and safe. Until now, this was seen as a prerequisite for the safe dosing of dialkyl dicarbonates. Therefore, only diaphragm pumps came into question for a person skilled in the conventional art.

### SUMMARY

An aspect relates to a method to overcome the disadvantages of the state of the conventional art for dosing dialkyl dicarbonates.

Surprisingly, a method and an apparatus have now been found which offer significant advantages over the diaphragm dosing pump.

The apparatus or the method is also much more economical than the methods used to date for preserving beverages.

An apparatus for preserving beverages according to embodiments of the invention has a measuring device which is suitable and intended for determining a flow rate of a liquid flowing through a beverage line, and a pump device which conveys and/or doses a preservative, in particular dialkyl dicarbonates, into the beverage line, wherein a delivery line is provided which opens into the beverage line and the pump device conveys the dialkyl dicarbonates through this delivery line, and wherein the pump device can be controlled as a function of a flow rate determined by the measuring device.

According to embodiments of the invention, the pump device is designed as a reciprocating pump and in particular as a reciprocating piston pump.

Within the scope of embodiments of the invention, therefore, an apparatus and a method for preserving beverages comprising a measuring device and, in particular, a flow measuring device and a reciprocating pump are described.

The use of a reciprocating pump is unusual because its design is more complex than that of a diaphragm pump. However, the main advantage of using a reciprocating piston pump is that it can be used more variably, in particular with regard to the flow rates.

Beverages in the sense of embodiments of the invention are non-alcoholic soft drinks, or all corresponding beverages of other jurisdictions, which partly use other classifications. Also suitable for embodiments of the invention are wine and mixed wine beverages, alcoholic beverages of 0.5-18% alcohol, for example beer or mixed beer beverages, juices, nectars, mixed juice beverages, iced teas etc. Carbonated and non-carbonated drinks are equally suitable. Beverages with a pH value greater than 5 are not desired in the sense of embodiments of the invention. In an embodiment, the beverages to be bottled have a pH value which is below or at 5.

Beverages in the sense of embodiments of the invention contain 70 up to 99.9% by weight of water, based on the total mass of the liquid.

In an embodiment, the measuring device is a flow measuring device. All possible types of flow measuring devices are suitable. In an embodiment, the flow measuring device is selected from a group of flow measuring devices comprising inductive flow meters, mass flow meters, mechanical flow meters or, for example, also sound wave flow meters or surface flow meters.

A reciprocating piston pump used according to embodiments of the invention typically has at least one movable piston-shaped pump body (in particular movable in a linear direction), which is particularly driven by an electric motor. In an embodiment, the motor is a controllable and in particular adjustable motor and particularly a servomotor.

This piston is typically located in a suitable housing (which is made of stainless steel in particular) and is moved back and forth repeatedly. The piston is typically sealed with suitable sealing devices and sealing rings in such a way that no or only negligible amounts of pumped liquid can escape. In an embodiment, less than 0.1 ppm, less than 0.08 ppm and/or less than 0.04 ppm can escape.

In addition, the reciprocating pump has a flushing device which is suitable for flushing out substances and, in particular, preservatives which get into areas behind the piston. The flushing can be carried out with a solvent or also with a gas, for example air.

In an embodiment, the pump device has at least one valve and at least two valves and in particular one-way valves through which the pumping performance is made possible. These valves can be designed as non-return valves. These valves are positioned in particular in front of and behind a chamber of the piston and can be brought into flow connection with the chamber. In this way, an inflow and outflow of the medium to be conveyed is achieved in a manner known per se, and the medium is thereby conveyed forward.

Further embodiments of the piston pump in the sense of embodiments of the invention can also include pistons used on both sides, in which the forward and backward movement is converted into delivery rate. Likewise, pumps with several pistons can be connected in such a way that the delivery and the delivery pressure are no longer pulse-shaped but relatively continuous. One speaks, for example, of binary, quaternary or dual pumps, all of which are suitable in the sense of embodiments of the invention.

In an embodiment, the pump device delivers a pulsed volume flow. In an embodiment, the pump device delivers a continuous or essentially continuous volume flow, for example a periodically fluctuating volume flow. A volume flow that does not drop below 10% of the maximum volume flow is also conceivable.

Examples of piston pumps in the sense of embodiments of the invention are, for example, petrol injection pumps. Further examples in the sense of embodiments of the invention are pumps originating from the analytical or preparative HPLC technique.

In an embodiment, the pump device has a variable delivery rate.

In an embodiment, of all the aforementioned pump devices, this pump device has a delivery rate that is greater than 0.01 l/h and/or greater than 0.02 l/h. In an embodiment, the pump device has a delivery rate which is less than 60 l/h, less than 50 l/h, less than 40 l/h, less than 30 l/h and/or less than up to 20 l/h.

In an embodiment, the pump device can be controlled in a power range in which the ratio between the lowest flow rate and the highest flow rate is less than 0.1, and/or less than 0.01. In this way, a wide variety of requirements for filling beverages can be met with a single type of pump.

The pumps can pump cyclically and/or deliver a pulsed volume flow, or they can also pump relatively continuously by utilizing valve circuits or the forward and backward movement of the piston.

No pumps within the meaning of embodiments of the invention are centrifugal, gear, diaphragm, helical, liquid jet, positive displacement, screw or peristaltic pumps. The applicant has determined in extensive studies and experiments that these aforementioned pumps are not suitable for meeting the very specific requirements arising from the use of the preservative.

In an embodiment, the pump device in the sense of embodiments of the invention is a self-priming pump. These are pumps which do not have to be filled with the liquid medium to be pumped when they are started up, can start up empty and, due to their ability, develop a suction effect even in a dry state and independently draw in the medium. The pump device used is therefore suitable and intended for pumping liquid substances, even if these are temporarily not in contact with the pump device.

In an embodiment, the pump device at least partially comprises materials which do not cause decomposition of the preservative and in particular do not cause decomposition of dimethyl dicarbonate. In an embodiment, at least those components of the pump device which come into contact with the preservative have a material (or consist of a material) which does not cause decomposition of the preservative and in particular does not cause decomposition of dimethyl dicarbonate.

In an embodiment, the material is passivated stainless steel. In an embodiment, therefore, at least individual components of the pump device have materials (or consist of materials) which do not cause decomposition of the preservative and in particular do not cause decomposition of dimethyl dicarbonate. In an embodiment, these components are selected from a group of components of the pump device comprising a piston of the pump device, a piston chamber of the pump device, conduits for conducting the preservative, valves of the pump device, sealing devices and the like.

In an embodiment, the valves of the pump device are ball valves. In an embodiment, the valve balls of these ball valves are made of a material that does not cause decomposition of the preservative and are made of ruby or passivated stainless steel.

In an embodiment, the pump device has a heating device for heating components of the pump device and, in particular, for heating components that come into contact with the preservative. For example, components such as the piston chamber, the piston or the valves or the pipes can be heated.

In an embodiment, the pump device has at least one temperature detection device for detecting a temperature of the preservative and/or of components of the pump device. In an embodiment, the pump device can also be controlled as a function of data or measured values which are recorded and/or output by this or these temperature recording device(s).

If the temperature of the preservative is detected to be too low, areas of the pump device can then be heated. If it is detected that the temperature is too low, it is possible to interrupt the supply of preservative to the pump device or to switch off the pump device.

In an embodiment, the apparatus according to the invention has a nozzle device which conveys and/or meters the preservative and, in particular, the dialkyl dicarbonate into the beverage line, wherein this nozzle device being a heatable nozzle device. It is also possible that the beverage to be filled is kept at a temperature of at least 20° C.

The pump device draws the preservative, in particular the dialkyl dicarbonate, from a storage vessel and pumps it to the nozzle device. The nozzle device sprays the preservative, in particular the dialkyl dicarbonate, into the beverage.

In an embodiment, the pump device delivers the preservative to the nozzle device under pressure, and under a pressure that is between 5 bar and 100 bar, and/or between 15 bar and 50 bar.

In an embodiment, the beverage is conveyed through the beverage line with a flow rate of 40 l/h-80000l/h.

In an embodiment, the lines connecting the reservoir and the pump device and/or from the pump device to the nozzle are made of stainless steel but can also be made of another metal or plastic.

Nozzles in the sense of embodiments of the invention are made of stainless steel and of passivated stainless steel.

In an embodiment, the nozzle device sprays the preservative and especially the dialkyl dicarbonate in finest form into the beverage, wherein the average droplet size is <0.1 mm. In an embodiment, the nozzle device opens on pressure or closes—in particular automatically—as soon as no more preservative or dialkyl dicarbonate is pumped, or when the preservative/dialkyl dicarbonate-side pressure falls below a predetermined limit, for example when the pressure drops below 10 bar.

In an embodiment, the nozzle device is heated in order to prevent crystallization of the dialkyl dicarbonates. The heating may, for example, take the form of an electric heating element which is controlled by a heating wire which heats up and which is in particular embedded in a metal body or placed directly around the nozzle. In an embodiment, the nozzle device can be heated in a range of 25° C. to 70° C., and/or in a range of 35° C. to 55° C.

Preservation is carried out against microorganisms such as bacteria, yeasts and fungi. In an embodiment, the preservation is carried out against microorganisms which are present in the beverage due to secondary contamination. The term preservation in the context of embodiments of the invention also includes sterilization, i.e., the case in which microorganisms are already present in the beverages before the preservatives are added. The preservatives then also act as sterilizing agents.

Dialkyl dicarbonates are used as preservatives. In an embodiment, dimethyl dicarbonate is used, and even more, dimethyl dicarbonate with a purity>99.8% is used as a preservative. In an embodiment of the invention, dimethyl dicarbonate is used which has been stabilized by suitable processes.

Such processes, such as the use of a phosphorus compound from the series of phosphorus oxides, phosphorus-oxygen acids and derivatives thereof, are known, for example, from EP 2 013 160 B1. EP 2 016 041 B1 describes the use of at least one protonic acid from the series of inorganic acids and organic carboxylic acids and derivatives thereof, wherein the organic carboxylic acids are saturated and mono- or polyunsaturated aliphatic monocarboxylic acids and saturated and mono- or polyunsaturated aliphatic di- and polycarboxylic acids and the derivatives thereof are hydroxamic acids, hydroxycarboxylic acids, aldehyde and keto acids, for stabilizing dialkyl dicarbonates against chemical and thermal degradation reactions, wherein the protonic acid or mixtures thereof being present in an amount of 0.01 to 100 000 ppm relative to dialkyl dicarbonates or mixtures thereof.

In an embodiment of the invention, dimethyl dicarbonate is used in a mixture with phosphorus compounds, such as phosphates, even more with trimethyl phosphate or phosphoric acid. In an embodiment, the phosphorus compound is used in an amount between 0.01 ppm and 1000 ppm based on the total amount of the mixture of dimethyl dicarbonate and phosphorus compounds.

In an embodiment, 0.1 ppm to 250 ppm preservatives are used in relation to the beverage volume. In an embodiment, 1 ppm to 250 ppm preservative is used based on the volume of the beverage.

In an embodiment, the pump device is arranged within a chamber or within a housing. In an embodiment, this housing is made of stainless steel. It is possible that this chamber or housing surrounds the pump device essentially completely (apart from the inlets and outlets for the preservative). In an embodiment, a storage container for the preservative is also arranged within this housing.

In an embodiment, the apparatus comprises an inactivation device for treating and in particular for deactivating preservative vapors and in particular dialkyl dicarbonate vapors.

In an embodiment, this inactivation device comprises at least one air circulation device and/or at least one filter device and in particular an activated carbon filter device.

In an embodiment, the apparatus comprises a detection device for detecting vapors and in particular preservative vapors.

In an embodiment, the delivery line opens into a curved section and/or deflection section of the beverage line. This is desired because the direction of flow of the beverage is changed in such a curved section and turbulence thus occurs, which favors the dosing of the preservative, i.e., results in a good distribution of the preservative in the beverage.

In an embodiment, the apparatus has a storage container for holding the preservative and, in particular, the dialkyl dicarbonate. In particular, the storage container is an exchangeable container. In an embodiment, the apparatus can have a holder for receiving this container.

In an embodiment, the pump device can draw off the preservative from this storage container. In an embodiment, the storage container is arranged below the pump device. In an embodiment, the storage container is in flow communication with the pump device or can be brought into such a flow communication.

In an embodiment, the flow measuring device is arranged in a flow direction of the beverage upstream of the position of the supply of the preservative or the dialkyl dicarbonates into the beverage line. In an embodiment, the flow measuring device is arranged at such a distance upstream (in the direction of flow of the beverage) of the position of the supply of the preservative that it is possible to react directly to a changing flow rate of the beverage at any time.

It is possible that the flow measuring device is a component of a filling system and its data is read out. In an embodiment, however, the apparatus according to embodiments of the invention is designed as a stand-alone device and can also be added to or retrofitted in existing filling systems (in particular also those systems which do not have their own flow measuring device).

In an embodiment, the apparatus has a monitoring device which is suitable and intended to detect leakages of the pump device. This can be, for example and, a camera which detects a leakage of liquids, for example in the area of the piston chamber. Alternatively, such a monitoring device can also be designed as a moisture sensor.

In this way, a leakage can be detected, in particular during operation of the apparatus. A warning signal can be emitted in response to this detection. It is also possible that the pump device is switched off when such a leakage is detected.

Embodiments of the present invention are further directed to a method for preserving beverages, wherein a flow rate of a liquid flowing through a beverage line is determined by a measuring device and a preservative, in particular dialkyl dicarbonate, is conveyed into the beverage line by a pump device and wherein a delivery line opens into the beverage line and the pump device conveys the preservative through this delivery line and wherein the pump device is controlled as a function of a flow rate determined by the measuring device.

According to embodiments of the invention, the pump device is designed as a reciprocating pump and in particular as a reciprocating piston pump.

In an embodiment, the method according to embodiments of the invention is carried out in such a way that the pumping device is switched on as soon as the filling process of the beverages begins. In an embodiment, an electronic control device is used which calculates the amount of preservative and, in particular, dialkyl dicarbonate to be dosed from the amount of beverage measured by the measuring device or at the flow meter. In this way, an independent and completely automated dosage can be achieved.

In a method, the preservative is dosed into the beverage line by a nozzle device, wherein this nozzle device is heated. In an embodiment, this nozzle device is heated electrically.

In a method, the nozzle device opens and closes in response to the pressure of the preservative.

In a method, the opening state of the nozzle device is controlled by a pre-pressure of the preservative in a delivery line and in particular the above-mentioned delivery line. In this case, it is possible that the preservative is introduced continuously or substantially continuously into the beverage flow and, in particular, is metered in. Alternatively, it is possible that the preservative is introduced into the beverage flow in pulses.

In an embodiment, the pump device has a weight which is less than 20 kg, less than 15 kg, and/or less than 10 kg. In an embodiment, the entire apparatus has a weight that is less than 100 kg.

In an process, preservative vapors and in particular dialkyl dicarbonate vapors are inactivated. This can be carried out by a filter device and/or an air circulation device. It is possible that the occurrence of such vapors is detected, and an air circulation device is activated accordingly.

Embodiments of the present invention are further directed to the use of a reciprocating pump for feeding a preservative into a beverage line during the filling of beverages.

### BRIEF DESCRIPTION

Some of the embodiments will be described in detail, with reference to the following figures, wherein like designations denote like members, wherein:

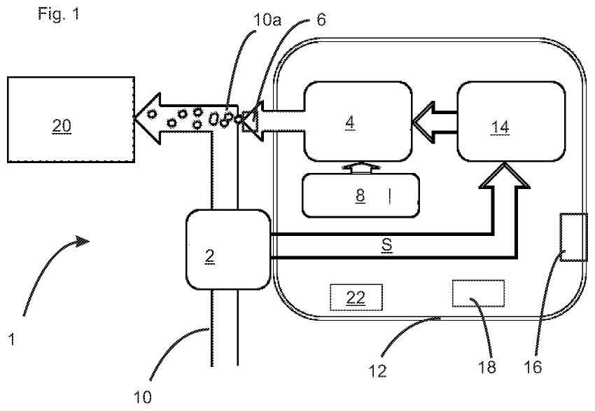

FIG. 1 shows a schematic representation of an apparatus according to embodiments of the invention.

### DETAILED DESCRIPTION

FIG. 1 shows apparatus 1 according to embodiments of the invention. The reference sign 10 refers to a beverage line which can lead, for example, to a filling device 20 which is only shown schematically. The reference sign 2 indicates a flow measuring device which—in particular continuously—detects a flow of the beverage through the beverage line 10. This flow measuring device 2 outputs a signal S to a control device 14, which controls the pump device 4 in response to this signal.

The pump device 4 is designed here as a reciprocating pump which sucks the preservative out of a storage container 8 and conveys it into a delivery line. A nozzle device 6 is arranged at the end of this delivery line, which delivers the preservative into an angled area 10a of the beverage line 10.

The pump device 4 is arranged, together with the storage container 8, within a housing 12. The reference sign 18 indicates a detection device which is suitable and intended to detect the presence of preservative vapors. The reference sign 22 roughly schematically identifies a circulation pump which is suitable and intended to effect circulation of the air within the housing 12.

The reference sign 16 indicates a deactivation device, such as an activated carbon filter.

The apparatus according to embodiments of the invention describes a new efficient apparatus and method with which the preservation process with dialkyl dicarbonate can be operated more economically and also in larger performance ranges. In addition, the entire apparatus can be made considerably smaller than the diaphragm dosing pumps usually used.

In a first example of the method according to embodiments of the invention, a device according to FIG. 1 is used. The storage container 8 contained dimethyl dicarbonate. The dimethyl dicarbonate used was the product Velcorin® from Lanxess Deutschland GmbH.

The pump device was connected to the inlets and outlets of the pipes with stainless steel tubes. A pipe was connected in front of the pump device, which allowed the dimethyl dicarbonate to be sucked in.

The internal electronics of the flow meter were used for electronic control and the signal received was sent directly to the pump device 4. The electronics of the flow meter thereby emits a volume—proportional control signal. With a 10 ml pump head and flow rates up to 3.5 ml/min at a back pressure of 50-85 bar, a fine spraying of the dimethyl dicarbonate into the beverage (water) could be observed. No droplet formation at the nozzle device was observed. The results confirm a uniform introduction and mixing of the dimethyl dicarbonate into the beverage. No leakage of the irritating dimethyl dicarbonate into the environment was observed.

In a further example, a stainless-steel nozzle was used as the nozzle device. This had a conical bore into which a conical counterpart was fitted. An increase in the applied pressure causes a gradual opening of this nozzle device. When the inlet pressure drops, the nozzle closes again automatically. This pre-pressure is in a range between 5 bar and 30 bar.

Iced tea was used as the beverage. From the methanol (MeOH) produced after 24 hours after hydrolysis, the dosed amount of dimethyl dicarbonate can be calculated back. The analysis of the beverages for methanol showed a uniform and controlled incorporation of the dimethyl dicarbonate (DMDC), as shown in Table 1 below.

TABLE 1

| | | Measured dosage DMDC | | |
|---|---|---|---|---|
| | | (measured/calculated via the | | |
| | | hydrolysis product MeOH) | | |
| Beverage flow | Target dosage | Sample 1 | Sample 2 | Sample 3 |
| rate | DMDC | 50 l/h | 500 l/h | 10000 l/h |
| High dosage | 250 ppm | 245 ppm | 245 ppm | 249 ppm |
| Low dosage | 90 ppm | 92 ppm | 90 ppm | 94 ppm |

The results confirm a uniform incorporation and mixing of the dimethyl dicarbonate in the beverage. The desired dosage is guaranteed. No leakage of the irritating dimethyl dicarbonate into the environment was observed.

The applicant reserves the right to claim all features disclosed in the application documents as essential to embodiments of the invention, provided they are individually or in combination new compared to the conventional art. It is further pointed out that the FIGURE also describes features which may be advantageous in themselves. The skilled person immediately recognizes that a certain feature described in a FIGURE can also be advantageous without adopting further features from this FIGURE. Furthermore, the skilled person recognizes that advantages can also result from a combination of several features shown in individual figures or in different figures.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. An apparatus for preserving beverages, having a measuring device which is suitable and intended for determining a flow rate of a liquid flowing through a beverage line, and having a pump device which conveys a preserving agent, into the beverage line, wherein a delivery line is provided which opens into the beverage line and the pump device delivers the preservative through this delivery line and wherein the pump device can be controlled as a function of a flow rate determined by the measuring device, wherein the pump device is constructed as a reciprocating piston pump.

2. The apparatus according to claim 1, wherein the apparatus has a nozzle device which conveys the preservatives into the beverage line, wherein this nozzle device being a heatable nozzle device.

3. The apparatus according to claim 2, wherein the nozzle device has an opening mechanism controllable by a pre-pressure of the preservative.

4. The apparatus according to claim 1, wherein the pump device is arranged within a chamber.

5. The apparatus according to claim 1, wherein the apparatus comprises an inactivation device for treating preservative vapors, wherein this inactivation device comprising at least one air circulation device and/or a filter device.

6. The apparatus according to claim 1, wherein the delivery line opens into a curved section of the beverage line.

7. The apparatus according to claim 1, wherein the apparatus comprises a storage container for receiving dialkyl dicarbonates.

8. The apparatus according to claim 1, wherein the measuring device is arranged in a flow direction of the beverage upstream of the position of the supply of dialkyl dicarbonates into the beverage line.

9. The apparatus according to claim 1, wherein the pump device has a variable delivery rate.

10. The apparatus according to claim 1, wherein the apparatus comprises monitoring device suitable and intended for detecting leakages of the pump means.

11. A method for preserving beverages, wherein a flow rate of a liquid flowing through a beverage line is determined by a measuring device and a preservative, is conveyed into the beverage line by a pump device, wherein a delivery line opens into the beverage line and the pump device conveys the preservative through this beverage line and wherein the pump device is controlled as a function of a flow rate determined by the measuring device, wherein the pump device is configured as a reciprocating piston pump.

12. The method according to claim 11, wherein the preservative is metered into the beverage line by a nozzle device, wherein this nozzle device being heated.

13. The method according to claim 12, wherein an opening state of the nozzle device is controlled by a pre-pressure of the preservative in the delivery line.

14. The method according to claim 11, wherein preservative vapors produced are inactivated.

15. A method comprising: utilizing a piston pump for supplying a preservative into a beverage line when filling beverages.

16. The apparatus according to claim 1, wherein the preserving agent is dialkyl dicarbonate.

17. The apparatus according to claim 11, wherein the preserving agent is dialkyl dicarbonate.

18. The apparatus according to claim 5, wherein the treating preservative vapors are dialkyl dicarbonate vapors.

19. The apparatus according to claim 5, wherein the treating preservative vapors are dialkyl dicarbonate vapors.
